(19) United States
(12) Patent Application Publication
(10) Pub. No.: US 2011/0225244 A1
(43) Pub. Date: Sep. 15, 2011

(54) TRACING DOMAINS TO AUTHORITATIVE SERVERS ASSOCIATED WITH SPAM

(75) Inventors: ZACHARY LEVOW, PALO ALTO, CA (US); DEAN DRAKO, LOS ALTOS, CA (US)

(73) Assignee: BARRACUDA NETWORKS INC., CAMPBELL, CA (US)

(21) Appl. No.: 12/030,339

(22) Filed: Feb. 13, 2008

(51) Int. Cl. G06F 15/16

(52) U.S. Cl. 709/206

(57) ABSTRACT

The invention provides a method and system for filtering email which may contain links to a large number of rapidly synthesized domains serving spam content by referencing a database of categorized authoritative servers, querying a domain name system server for an authoritative server associated with domain names embedded in email, and accessing the database of categorized authoritative servers for a match.

### CO PENDING APPLICATIONS

A related co-pending application with common inventorship and assignment is domain redirection analysis.

### BACKGROUND

Unsolicited bulk email messages commonly called spam are nearly free for the sender to send and they are being sent in large growing volumes. They are expensive to the receivers in wasted resources, fraud, and lost productivity. A common goal of spam is to deliver a political, malicious, or commercial message by inducing the recipient of the email to visit a website. A series of rapidly changing Uniform Resource Identifiers may disguise the final destination where information such as purchasing data is procured.

Referring now to FIG. 1, a flowchart, a plurality of caching servers 150 resolve a domain name such as uspto.gov to an Internet protocol address such as 123.45.67.89 which may be a web page which has content 130 or which redirects through one or more further redirections to a web page with content 140. A spammer 160 manages an authoritative server 121 through which he may rapidly proliferate domains 130. The spammer may distribute e-mail 170 which contain a link to a domain. When the email client follows the link, his caching server obtains both the internet protocol address as well as the authoritative server associated with the domain.

Conventional methods provide for filtering spam either at the desktop or at a mail server. It is common knowledge to those skilled in the art to examine subject lines and message content for certain keywords to determine that an email is likely to be spam. This conventional process is called content filtering. Conventional content analysis of emails also includes keyword searches on the header of an email and image recognition or pattern matching of the body. Spammers have anticipated this by embedding only links to the content, in some cases dithered image content with no fixed signature, and rapidly replacing domains which provide the actual content.

Thus it can be appreciated that what is needed is a way to discern email from spammers who direct email recipients to view content by changing domain names of Uniform Resource Identifiers embedded in the email more rapidly than content filters can be updated.

### BRIEF DESCRIPTION OF FIGURES

FIG. 1 is a block diagram of a domain name system and internet artifacts.

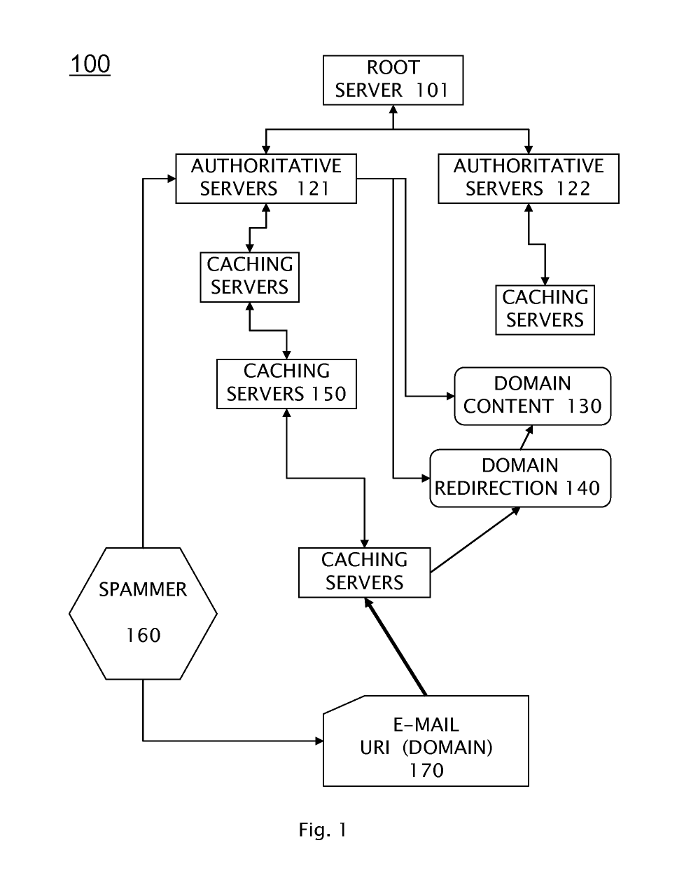

FIG. 2 is a flowchart of a method of filtering spam.

### SUMMARY OF THE INVENTION

The present invention is a method for analysis of electronic documents. Specifically the invention may be applied to email which may contain links to resources on the Internet, typically but not limited to webpages. The method presumes having compiled a database of authoritative servers associated with a category of email. The method firstly locates a domain embedded in an electronic document. By querying the domain name system, which may require several steps, the method finds an authoritative server. By referencing a database of categorized authoritative servers and finding a match, the method addresses a large number of rapidly synthesized domains. It is the observation of the inventor that an authoritative server owned by a spammer may frustrate conventional content analysis by generating domains faster than they can be identified in content analysis databases as characteristic of spam.

### DETAILED DISCLOSURE OF THE INVENTION

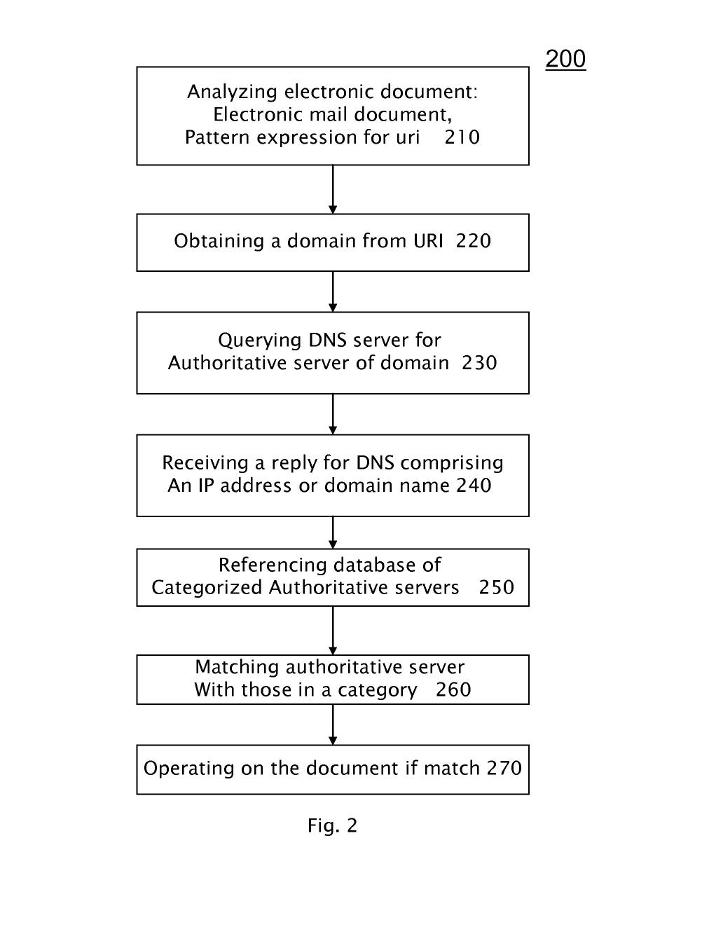

Referring now to FIG. 2, the present patent application discloses a method for analysis of spam email having the processes of analyzing an electronic document. This process includes the step of querying caching server, a root server, or a top level domain server for an authoritative server of a domain. The method includes the step of referencing a database of authoritative servers of a category and matching an authoritative server with those in a category. Depending on the category a variety of operations may be performed if there is a match with a member of the database of categorized authoritative servers from displaying a warning in the header or body of the mail to quarantine or deletion of the email.

The invention may be better understood in the following embodiment which may be appreciated by those skilled in the art as not limiting the scope of the invention:

An embodiment of the present invention is illustrated in FIG. 2, a method for filtering email, comprising the following processes:
analyzing an electronic document for a pattern expression corresponding to a uniform resource identifier (URI) 210;
obtaining at least one domain from a URI embedded in the electronic document 220;
querying a domain name system (DNS) server for at least one first authoritative server for the domain 230,
receiving a reply from a DNS server wherein an authoritative server comprises one of an internet protocol (IP) address and a domain name 240;
referencing a database of categorized authoritative servers 250;
matching a first authoritative server received from a DNS server with any member of the database of categorized authoritative servers 260; and
if matching, operating on the electronic document 270.

The step of querying a DNS server may be accomplished by one of the following:
querying a caching server,
querying a top level server, and
querying a root server.

In an embodiment, the method for analysis of electronic documents to detect and remove undesired electronic mail documents commonly called spam from a mail server or gateway, comprises the processes of
extracting a domain from a uniform resource identifier embedded within an electronic document,
obtaining all the authoritative servers for the domain in the domain name system by querying a root or caching server,
referencing a database of authoritative servers which are in a category,
matching any one authoritative server for the domain with a member of the database of authoritative servers which are in a category and removing the email if there is a match.

This embodiment addresses a large number of previously unknown and rapidly proliferating domains which contribute to disguise a spam source. This situation may be efficiently identified to an email filter by checking each domain's authoritative server with a database.

The method may be improved by further comprising the step of creating a database of authoritative servers which are in a category. Authoritative servers may be represented as internet protocol addresses, address ranges, or domains.

The method may be extended by further comprising the step of operating on an electronic mail document if a database of authoritative servers contains the authoritative server of a domain found within the electronic mail document.

In an embodiment referencing is the step of accessing a remotely attached computer readable media tangibly embodying a database.

In an embodiment referencing is the step of accessing a locally attached computer readable media tangibly embodying a database.

Further operating on a electronic mail document may include categorizing the email into a category, blocking the email from its addressee, quarantining the email into a special folder, and setting or adjusting a score of an email in a spam filtering system.

An apparatus which couples a computer controlled by instructions encoded on computer readable media on which is encoded the method is also disclosed. A system which contains a server which provisions a database of authoritative servers and further contains an apparatus which performs the steps of the method is also disclosed. By computer system is meant components coupled via communication channels including a processor, an input device, an output device, network communication adapters, and computer readable storage media adapted to control the system by the methods disclosed. The invention is tangibly embodied as a computer program, a component for use in a computer system, and a system comprising a database of servers and an email examiner.

### CONCLUSION

The present invention addresses a severe problem in diluting the productivity of internet based communications with automated generation of unwanted email and rapid creation of domains which provide content that is potentially malicious or at least time consuming to discard or block. It has been observed by the inventor that control over an authoritative server by a spammer may be used to frustrate conventional content analysis. The present invention traces a domain to its authoritative server through queries to domain name system server or servers. This may be via a root server, a top level domain server, or to a caching server. By referencing a database of authoritative servers identified as spammer friendly, the invention provides dynamic analysis adaptability to content filtering and consequent reduction of spam email.

By identifying the authoritative servers that provide internet addresses for domains which are used for spam, a method for identifying email which embeds links to spam sites is enabled. The present invention is a method for analysis of spam email by matching the authoritative servers of spam hosts with embedded links in email.

The invention provides a method and system for analysis of electronic documents which may contain links to a large number of rapidly synthesized domains serving spam content by compiling a database of authoritative servers associated with spam domains, tracing a domain embedded in an electronic document to its authoritative server, and accessing the database of authoritative servers for a match.

What is claimed is:

1. A method for filtering an electronic document, comprising the following processes:
analyzing an electronic document for a pattern expression corresponding to a uniform resource identifier (URI) 210;
obtaining at least one domain from a URI embedded in the electronic document 220;
querying a domain name system (DNS) server for at least one first authoritative server for the domain 230,
receiving a reply from a DNS server wherein an authoritative server comprises one of an internet protocol (IP) address and a domain name 240;
referencing a database of categorized authoritative servers 250;
matching a first authoritative server received from a DNS server with any member of the database of categorized authoritative servers 260; and
if matching, operating on the electronic document 270.

2. The method of claim 1 wherein an electronic document comprises an electronic mail document.

3. The method of claim 2 wherein operating on an electronic mail document comprises quarantining the electronic mail document.

4. The method of claim 2 wherein operating on an electronic mail document comprises blocking the electronic mail document from transmission to the addressee.

5. The method of claim 2 wherein querying a DNS server comprises querying a caching server.

6. The method of claim 2 wherein querying a DNS server comprises querying a top level server.

7. The method of claim 2 wherein querying a DNS server comprises querying a root server.

8. A method comprising the following processes:
analyzing an electronic mail document for a pattern expression corresponding to a uniform resource identifier (URI) 210;
obtaining at least one domain from a URI embedded in the electronic document 220;
querying a domain name system (DNS) server for at least one first authoritative server for the domain 230,
receiving a reply from a DNS server wherein an authoritative server comprises one of an internet protocol (IP) address and a domain name 240;
referencing a database of categorized authoritative servers 250;
matching a first authoritative server received from a DNS server with any member of the database of categorized authoritative servers 260; and
if matching, adjusting a score of an electronic mail document in a spam filtering system.

9. A method comprising the following processes:
analyzing an electronic mail document for a pattern expression corresponding to a uniform resource identifier (URI) 210;
obtaining at least one domain from a URI embedded in the electronic document 220;
querying a domain name system (DNS) server for a plurality of authoritative servers for the domain 230,
receiving a plurality of replies from a plurality of DNS servers wherein an authoritative server comprises one of an internet protocol (IP) address and a domain name 240;
referencing a database of categorized authoritative servers 250;
matching each authoritative server received from a plurality of DNS servers with any member of the database of categorized authoritative servers 260; and
if matching, operating on the electronic mail document 270.

10. The method of claim 9 wherein operating on the electronic mail document comprises categorizing an electronic mail document into a category by associating it with an authoritative server.

11. The method of claim 9 wherein operating on the electronic mail document comprises quarantining the electronic mail document into a folder separate from electronic mail which is not matched in a category of categorized authoritative servers.

12. The method of claim 9 wherein operating on the electronic mail document comprises blocking an electronic mail document from transmission to its addressee.

13. The method of claim 9 wherein querying a domain name system (DNS) server for a plurality of authoritative servers for the domain 230 comprises querying for the start of authority; parsing a domain from right to left beginning with the base domain below a top level domain; and querying again for each child domain until an authoritative server is found.

14. A computer program embodied on a computer-readable medium for . . . , comprising: a code segment that at least maintains a database of categorized authoritative servers 250;
a code segment which matches each authoritative server received from a plurality of DNS servers with any member of the database of categorized authoritative servers 260; a code segment which on the condition of a match, operates on an electronic mail document 270 containing a domain corresponding to said authoritative server.

15. A component for use in a computer system, comprising:
an electronic document examination unit which analyzes an electronic mail document for a pattern expression corresponding to a uniform resource identifier (URI) 210;
obtains at least one domain from a URI embedded in the electronic document 220;
queries a domain name system (DNS) server for a plurality of authoritative servers for the domain 230, and
receives at least one reply from a plurality of DNS servers wherein an authoritative server comprises one of an internet protocol (IP) address and a domain name 240.

16. A system for tracing domains to authoritative servers associated with spam, said system comprising: a database of categorized authoritative servers, an email examiner adapted to determine a domain from a uniform resource identifier embedded in an email, query a domain name system server for an authoritative server associated with domain names embedded in email, and access the database of categorized authoritative servers for a match.
